(19) United States
(12) Patent Application Publication
(10) Pub. No.: US 2006/0099361 A1
(43) Pub. Date: May 11, 2006

(54) Method for producing elements from phase change material

(76) Inventors: Dieter Jablonka, Herdecke (DE); Michael Mertens, Hagen (DE); Eberhard Schepers, Herdecke (DE)

Correspondence Address: BACHMAN & LAPOINTE, P.C., 900 CHAPEL STREET, SUITE 1201, NEW HAVEN, CT, 06510, US

(21) Appl. No.: 10/540,120

(22) PCT Filed: Dec. 22, 2003
(86) PCT No.: PCT/EP03/14758

§ 371 Date: Oct. 24, 2005

(30) Foreign Application Priority Data
Dec. 20, 2002 (DE) 102 61 208.0

(51) Int. Cl. B32B 27/32

(52) U.S. Cl. 428/35.2

(57) ABSTRACT

The invention relates to a method for producing elements from or comprising a material with a high heat storage capacity, especially from or comprising a phase change material abbreviated in the following as PCM which are provided with a cover. The aim of the invention is to provide elements from or comprising PCM that are suitable for a wide range of applications and that can be processed without complications. For this purpose, PCM is supplied continuously or in a clocked manner, is covered with a tube and the PCM-filled tube is subdivided into tube sections or stored, for example wound up.

### BACKGROUND OF THE INVENTION

(1) Field of the Invention

The invention relates to a process for producing elements made from or comprising latent heat storing material—abbreviated in the following as PCM [phase change material]—, which are provided with a tube, as well as to elements consisting of or comprising PCM.

In this context the definition “element” denotes PCM of any shape, type, consistency, colour, particle size, namely bodies such as panels, profiles, tubes, blocks, balls, granules, pockets, powders etc.

(2) Prior Art

From U.S. Pat. No. 5,770,295 structures and components are known for the heat insulation of rooms of buildings, in which PCMs are used for regulating the temperature conditions in the rooms. PCMs are connected to or integrated into carriers according to various methods, for example by saturating sheeting in PCM-baths or by spraying liquid PCM onto insulating materials or by introducing coated PCM-beads into structural elements having a foam-like structure. The PCM-carriers are, in principle, only inserted as an intermediate layer between two insulating material layers for the heat insulation of rooms.

### SUMMARY OF THE INVENTION

In view of this prior art the object arises to provide a method by means of which elements may be produced from or comprising PCM most efficiently, suitable for a broad field of application and permitting simple processing.

Based on a process of the type mentioned in the opening paragraph, this object is attained according to the invention in that
the tube is extruded from synthetic material,
PCM is fed continuously or intermittently,
PCM is filled or introduced into the freshly extruded tube and
the PCM-filled tube is subdivided into tube sections or is stored, for example coiled up.

In the process, PCM may be supplied in liquid or granular form or as a strand in sections or in endless form. Depending on the intended use, the PCM-filled tube may be flexible or rigid.

Advantageously, the tube consists of diffusion-proof plastics so that no PCM can escape from inside the sheathing and, conversely, no particles can penetrate from outside into the tube interior. In the case of paraffin-based PCM, polyamide (PA), for example, is considered acceptable as synthetic material, in particular for the manufacture of a flexible tube. In the event of using PCM based on a salt, polyethylene (HDPE) or polypropylene (PP) or in this case as well polyamide (PA) may be used as plastics for a flexible tube. The cross-sectional shape of the tube corresponds to the intended use. The same applies to the cross-sectional dimensions, which may be a few square millimetres or considerably larger areas—depending on the desired storage capacity per unit of length.

For the manufacture of PCM-elements on a relatively large scale, the tube is extruded in the production plant PCM is filled or introduced into the freshly extruded tube. Preferably, the tube, after leaving the extruder nozzle and prior to its entry into a cooling zone, should be filled with PCM—preferably in liquid form. It is also possible to feed PCM as a strand in a solid state having a predetermined cross-section, for a example a flat oval cross-section and to pass the strand through a bath for producing a coating or to manufacture the sheathing by spraying on liquid plastics. However, as stated above, filling a tube with liquid PCM is preferred, the said tube emerging from an extruder nozzle continuously and already having a dimensional stability adequate for filling with liquid PCM. PCM is in this case fed preferably centrally through the extruder nozzle into the tube being formed, preferably in a vertical direction of operation.

Depending on the intended use, the tube, after having been filled with PCM, i.e. with PCM-granular material or, preferably with PCM in its liquid state, is subdivided into tube sections of appropriate length or stored on a carrier such as a spool for further processing elsewhere. The length of the tube sections depends likewise on their intended use and may be a few millimetres or even several metres. In any event, the selected PCM material is securely enveloped and the PCM-filled tube sections may be conveyed for further processing.

The PCM-filled tube made of plastics may be constricted at predetermined locations in order to form tube sections and the constrictions may be heat sealed. This process step results in strands consisting of tube sections, which, as will be described further below, may be processed further for the production of insulating and/or heat storing elements. As an alternative, the PCM-filled tube sections may also be separated from one another at the constrictions, the constrictions preferably being severed, i.e. in such a manner that the tube section ends remain sealed.

For the formation of the tube sections by constricting the tubes at predetermined locations and for sealing the constrictions, various processes may be applied. The PCM-filled tube may, in particular, be passed through a press and the constrictions and heat sealing thereby may be brought about by means of heated pressing tools. In this case the tube may be constricted and heat sealed at the predetermined locations one by one by reciprocating pressing tools. For constricting and heat sealing, the tube may alternatively be passed between two counter-revolving endless belts, equipped with pressure and heat sealing tools. According to a further alternative, the tube is transported between two wheels, the peripheries of which are equipped with pressure and heat sealing tools. Each possibility provides suitable and economical methods, in particular, for a continuous production of tube sections of virtually any size regarding tube lengths and their cross-sectional dimensions as well as cross-sectional configuration.

Thus, for example a granular material consisting of PCM-filled pockets may be manufactured from tube sections separated from the strand. For the formation of latent heat storing units this granular material may serve to fill cavities in walls of buildings as well as in receptacles or chambers in construction or insulating panels.

Individual PCM-filled tube sections or such tube sections forming a coherent strand, may, however, also be affixed to a carrier, for example a plastics non-woven fabric or to a plastics foil, which is more or less flexible, so as to produce construction or insulation elements by means of which the properties of PCM may be utilised as heat storage means.

The tube sections may in this case be arranged parallel side-by-side on the non-woven fabric or the foil.

Flexible carriers comprising PCM-filled tube sections, in particular as products for construction purposes, may, by coiling, be readily stored, transported, handled and cut to an appropriate length. For other requirements rigid foils are to be preferred as carriers of the tube sections.

It is particularly advantageous to arrange and position the PCM-filled tube sections between a non-woven fabric and a film in laminated form. Such a semi-finished product may in an industrial context be produced economically in that, for example, a continuous non-woven fabric and a continuous strand of PCM-filled tube sections are brought together in the nip of a roller pair and bonded together there as well as coated with the film from an extruder nozzle on the side facing away from the non-woven fabric. Ideally, the manufacture of the continuous strand of PCM-filled tube sections immediately precedes the manufacture of such a continuous sheet comprising PCM-filled tube sections, so that the manufacture of this multi-layered sheet material may be performed in a production line. When manufacturing the sheet material, the film may in each case be drawn over the tube sections up to the non-woven fabric and be fixed onto the non-woven fabric between adjacent tube sections. In this manner, the film imparts a protective layer to each tube section at those locations which are not covered by the non-woven fabric and by doing so the said protective layer fixes each tube section in the desired position on the non-woven fabric. For this purpose, a continuous non-woven fabric and tube sections, individually fed from a hopper, may be brought together in the nip of a roller pair, where the tube sections are coated with the film from an extruder nozzle and fixed between the tube sections by adhesively bonding the film to the non-woven fabric.

Elements and further developments according to the invention are apparent from the claims. The elements—depending on their design—constitute finished or semi-finished products and are destined, in particular, for construction purposes. A typical application of elements according to the invention is described in what follows by way of an example of lightweight constructions.

Industrial buildings such as production halls and warehouses etc. are nowadays, to a large extent, erected as lightweight constructions. They consist of steel structures, which are subsequently insulated and clad in the wall and roof regions, depending on requirements.

The roof of lightweight constructions normally consists of plastic-coated profiles of sheets having trapezoidal corrugations, placed on the supporting steel structure and screwed to the latter. The profile panels are interconnected by rivets. After fitting, the sheets having trapezoidal corrugations are resistant to bending and may be walked on. Above the sheets having trapezoidal corrugations, as a further roof structure, normally a vapour seal, e.g. consisting of a self-adhesive thick foil, heat insulation having a layer thickness of about 160 mm and finally a flat roof seal are provided consisting of two layers of bitumen sheeting or a layer of a suitable plastics sealing sheet.

In order to improve heat insulation, so-called bead fillers are inserted made of insulating material, the bead fillers having been cut to the shape of the corrugation. For the improvement of sound insulation of industrial lightweight roofs, the metal sheet may be perforated in the region of the corrugation and an insulating material strip may be placed into the corrugation as such.

The temperature performance of lightweight constructions is problematic, because the buildings heat up rapidly to high temperatures in summer while cooling down rapidly in winter.

The invention permits to utilise the space provided by the corrugations of the layer or of the profiles of sheets having trapezoidal corrugations, to accommodate a storage mass for absorbing thermal energy. In contrast to solid construction elements of considerable weight, which can likewise be used as heat storage means, but which would exceed the load capacity of the lightweight structure, elements comprising PCM may be specifically selected and introduced in a simple manner into the corrugations of the profile layer. On hot summer days these heat accumulators would cause a lowering of the temperature underneath the sheet metal roof while releasing heat when cool night temperatures prevail, so that overall a balanced climate is brought about in the room interior.

For a better understanding, the invention is primarily elucidated with reference to profiles of sheets having trapezoidal corrugations for the roofs of lightweight constructions, even though the use of the elements according to the invention is in no way restricted thereto.

PCM may consist of a plurality of enveloped elements and is preferably accommodated in cavities, such as chambers, honeycomb structures or the like. Depending on the material type, the PCM-elements may also be introduced into cavities as granules, such as into the corrugations of profiles of sheets having trapezoidal corrugations. However, the elements may also consist of strands, which may be easily cut to length.

The effect of the PCM as a compensating element between high and low ambient temperatures is particularly long-lasting if the phase change temperature of the PCM is in the range of 15-40° C., in particular in the range of 20-35° C. When selecting the PCM, the temperatures prevailing in this case at the site of application of the layer must be taken into account, so that the phase change heat of the PCM may be utilised for balancing the different temperatures. In an assumed example of application, where e.g. cool outdoor temperatures of about 10° C. act on a flat roof equipped according to the invention and, therefore, also on the corresponding layer, the PCM is in a solid or solidified state. If the phase change temperature of this material is 25° C., the transition of the PCM from the solid to the liquid phase with corresponding heat absorption or corresponding energy consumption comes about as a result of higher ambient temperatures in the range of e.g. 25-30° setting in, with the result that warming up of the layer and, therefore, of the room interior is delayed accordingly. The more PCM is used and the higher the heat storage capacity of the material, the longer the room interior maintains a pleasant climate. Conversely, the interior cools down in the evening or at night at a substantially slower rate and reaches a correspondingly lower reduction of the indoor temperature, if the elements consisting of PCM, as a result of temperatures dropping below the phase change temperature of 20° C., release latent heat over an extended period of time until, depending on the time of action, they may revert entirely into the solid phase. For as long as they release latent heat, they prevent an abrupt temperature drop in the region of the layer and, as a result, in the room interior.

In the elements in the cavities, in particular in the corrugations or chambers, the PCM is sealed from the environment by a barrier, in particular, it is surrounded by a sealing, in particular also a diffusion-proof sheathing. The sheathing serves both to protect the PCM, which may otherwise e.g. evaporate or be impaired in its function by other materials penetrating the sheathing, as well as to prevent direct penetration of PCM into the corrugations and from there possibly into the atmosphere.

The sheathing is preferably flexible and allows form variations of the elements comprising PCM in a pulverised, granular, liquid or paste-like state. A flexible sheathing of the elements, e.g. a plastics tube, provides a number of advantages, such as normally light weight, easy transport, simple assembly, i.e. easy introduction of the elements into the corrugations, easy adaptation to the shape of the corrugations etc. If, for example, a PCM is selected and provided with a suitable sheathing, it may be introduced into the corrugation either in a molten or in a solid state. In the event that lower outdoor temperatures bring about the solid state of the PCM of the elements at the time of introducing the elements into the corrugations, melting of the PCM with corresponding adaptation to the shape of the corrugation takes place as soon as the outdoor temperatures rise and the PCM melts. From that point of view an adaptation to the shape of the corrugations is also attained, with a time lag, with elements consisting of PCM in a solid state at the time of introducing the elements, if the sheathing has appropriate flexibility. Adaptation to the shape of the corrugation essentially denotes that an element comprising a sheathing, e.g. approximately of circular cross-section, after introduction into the corrugation, adopts a flattened configuration at the bottom of the corrugation.

In the case of longitudinally extending cavities such as corrugations, the tubular sheathing should be subdivided into individually sealed tube sections, which may be arranged in the cavities individually and/or interconnected as a strand. A tubular sheathing having PCM subdivided in this manner into sections offers the advantage that in the event of leaks as a result of damage only individual tube elements and not the whole tube length are affected or are leaky. Moreover, the tube length required for any particular case can be readily brought about by cutting the connection between two tube elements. In addition, individual tube elements or even short tube sections consisting of a plurality of tube elements—even in the form of a granular material—are available in this manner for a uniform distribution of the PCM in the cavities, such as the corrugations.

The sheathing of the PCM made of a tear-resistant, impervious and diffusion-proof plastics foil may be composed of a plurality of layers. In this case the function of mechanical strength is attributed, for example, to one layer, namely e.g. a woven fabric or a non-woven fabric, while other layers perform, for example, the sealing function. Explicit reference is made to the material details mentioned above by way of example for the sheathing or the tube made of plastics.

The PCM should have the highest possible latent heat, so that the temperature compensating effect of the PCM results in a largely balanced climate in the interior of buildings concerned in the present case.

The PCM may consist of a wax, for example a paraffin mixture such as eicosane, nonadecane or oktadecane.

As an alternative, the PCM may consist of salt, salt hydrate, e.g. calcium chloride hexahydrate or lithium nitrate-trihydrate.

Elements according to the invention are, however, not restricted in any way to the use in flat roofs only, but, if appropriately designed, may also be used for pitched roofs or walls. To prevent the elements from shifting due to the weight of the PCM, structural inserts comprising transverse webs may be inserted at the bottom of the cavities or corrugations, e.g. in the case of walls or pitched roofs or the like, which prevent sliding or shifting of the elements made of or comprising the PCM. The elements in the corrugations may also be adhesively bonded spot-wise or section-wise, in particular if the elements are positioned vertically, when sagging of the elements should be avoided, in particular if they consist of a row of individually sealed tube elements, which may be interconnected in a row and may be very short tube elements. In this case, they are preferably processed as cords or strands.

### BRIEF DESCRIPTION OF THE DRAWINGS

The invention will be elucidated in more detail in what follows with reference to the drawings. There is shown in the drawings:

FIG. 1 a schematic illustration of a plant for the production of a continuous strand of PCM-filled tube sections;

FIG. 2 a schematic illustration of a detail Y of the plant according to FIG. 1;

FIG. 3 a schematic view of a detail X of the plant according to FIG. 1;

FIG. 4 a schematic view of a detail Z as alternative to detail X of FIG. 3 in the plant according to FIG. 1;

FIG. 5 a schematic plan view of a plant for the production of PCM-filled tube sections as granulated material;

FIG. 6 a schematic illustration of part of the plant for the continuous production of a web- or strand-like semi-finished product comprising PCM-filled tube sections;

FIG. 7 a schematic side elevation of part of a plant for the production of endless sheets with integrated PCM-filled tubes or PCM-filled tube sections;

FIG. 8 a cross-sectional view of part of a building as a lightweight construction comprising a flat roof using profiles of sheets having trapezoidal corrugations including corrugations, wherein elements consisting of PCM are arranged;

FIG. 9 a schematic view of a strand of PCM-elements in a side elevation.

### DETAILED DESCRIPTION OF THE PREFERRED EMBODIMENT(S)

In the embodiment illustrated in FIG. 1 of a plant for the continuous production of an endless strand 5 of PCM-filled tube sections 6, a stage 1 for the production of the strand 5 comprises a stage 2 for the withdrawal of the strand 5 as well as a stage 3 for cutting the said strand 5 or a stage 4 for coiling up the strand 5.

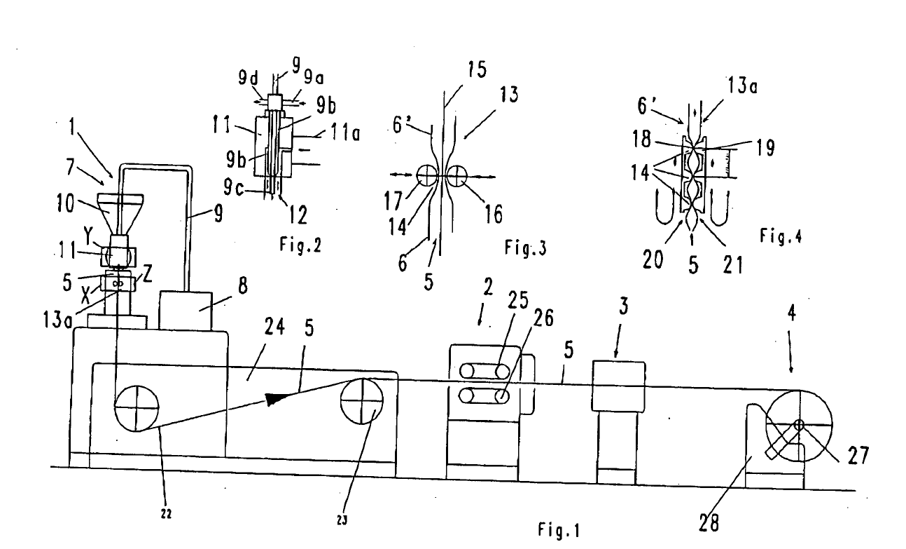

In stage 1, liquid PCM is supplied centrally, as shown, to an extruder 7 from a receptacle 8 via a duct 9. The transport and operating direction in the extruder 7 is preferably vertical, as illustrated. From a heating device 10 heated plastics is fed via a duct 11a to an extruder head 11 for continuously producing a continuous tube 12. As shown in FIG. 2, the liquid PCM is so introduced into the tube 12 immediately after its formation that underneath the outlet of the extruder nozzle 11 the PCM-filled strand is formed.

The liquid PCM supplied via the duct 9 is fed via a dosage or feed pipe 9c, passing centrally through the extruder head 11. From the end of the said dosage or feed pipe 9c projecting at the bottom, PCM is fed into the just formed and still hot tube 12. To ensure that the PCM maintains the feed temperature or, in any event, is heated only within permissible limits—depending on the PCM material—while being fed through the extruder head 11, a coolant circuit is arranged on and in the extruder head 11. In the present example the latter consists of a duct 9a for feeding the coolant to a cooling jacket 9b, extending coaxially through the extruder head 11, from which cooling jacket 9b the cooling agent is withdrawn again via a duct 9d. The drawn-in arrows illustrate the supply of the plastics to the extruder head 11 and the emergence of the tube 12 from the nozzle aperture as well as the exit of the liquid PCM from the lower end of the feed pipe 9c.

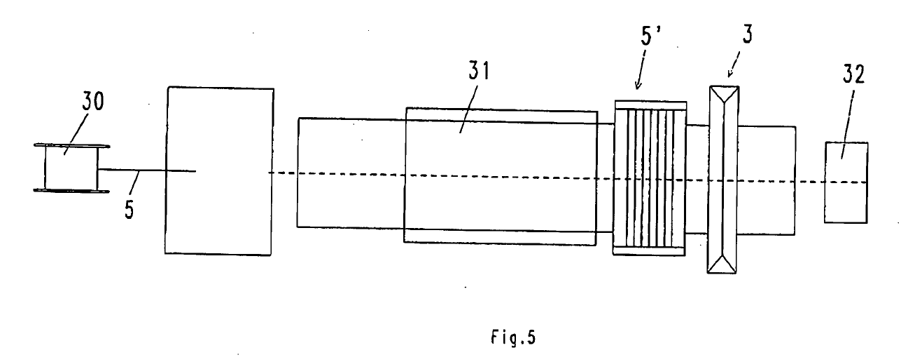

Immediately after filling the tube 12 with liquid PCM, the strand 5 passes through a heated pressing device 13 (FIG. 3) or 13a (FIG. 4), denoted in FIG. 1 by X, Z respectively. The strand 5 while still hot is now constricted intermittently and so heat sealed at the constrictions 14 that the strand 5 now consists of tube sections 6, interconnected by way of the heat sealed constrictions 14.

In the embodiment according to FIG. 3 (detail X) the constrictions 14 are formed by heated pressing tools 16, 17 reciprocating at intervals in a direction normal to the advance direction 15 of the strand 5. As a result, the tube sections 6 are heat sealed at both ends.

In the embodiment according to FIG. 4 (detail Z) the strand 5 is transported between two counter-revolving endless belts 20, 21, equipped with pressure and heat sealing tools 18, 19 and provided with constrictions 14 at predetermined locations and heat sealed at these points. As in the embodiment according to FIG. 3, tube sections 6′ come about, heat sealed at both ends, which are interconnected via the heat sealed constrictions 14 and which thus still form an endless strand.

The continuously manufactured endless strand 5 consisting of PCM-filled tube sections is guided via deflector rolls 22, 23 through a cooling means 24 and from stage 1 via stage 2, provided with transport means 25, 26, either to stage 3 or to stage 4. In stage 3, depending on the desired product, a subdivision of the strand 5 into individual tube sections 6 is performed by severing the constrictions 14 between the tube sections 6. Or the strand 5 is subdivided into strand sections consisting of a plurality of still interconnected tube sections 6. However, instead of stage 3 the strand 5 may also be fed to stage 4 for being coiled onto a spindle 27 in a coiling device 28. Depending on the intended use, the coiled strands so formed are further processed elsewhere.

In the embodiment according to FIG. 5 PCM-filled tube sections are manufactured in the form of a granular material. Rods consisting of or comprising PCM, provided with a flexible synthetic sheathing or a coiled strand 30 comprising a PCM-filling are fed through a tunnel oven 31 to a pressing and heat sealing stage 5′ for heating up the PCM as well as the synthetic sheathing. By producing and heat sealing constrictions, the strand 5 is likewise divided there into tube sections, which are sealed at both ends. If, as in the present case, a granular material is to be produced from PCM-filled tube sections, an appropriately short length in the range of 3 to 7 mm is selected for the tube sections in stage 5′, the cross-sectional dimensions of the strand 5 likewise being as small as possible. They are in the range of 3 to 7 mm. The strand 5 consisting of PCM-filled tube sections subsequently passes through the cutting stage 3, where the tube sections of appropriately short length are separated from one another and are subsequently gathered in a receptacle 32 as a granular material.

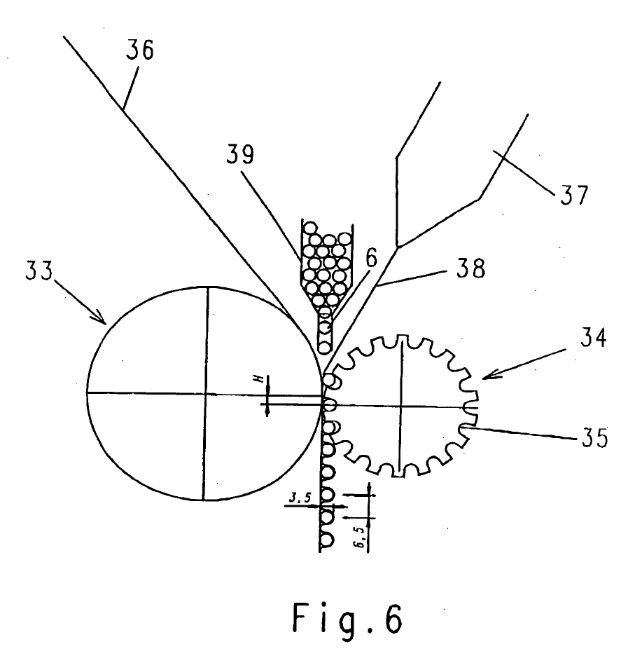

In the embodiment according to FIG. 6 two rolls, namely a feed roll 33 and a counter roll 34 comprising uniformly disposed recesses 35 on the circumference, are arranged in the manner shown in the drawing, i.e. axially offset in relation to their levels H. An endless non-woven fabric 36 is fed continuously towards the roll nip as a carrier material and is brought together there with a film 38, discharged by an extruder nozzle 37, for integrating PCM-filled tube sections 6 in tubular form, fed from a hopper 39. In the process the PCM-filled tube sections 6 are kept and guided in the receiving apertures 35 of the counter roll while being brought together. In the region of the roll nip the tube sections 6 are coated with the film 38 from the extruder nozzle 37 and the film 38 is adhesively bonded to the non-woven fabric 36 between the tube sections 6. This arrangement and mutual connection always imparts to the tube sections 6 a predetermined position on the non-woven fabric 36 as well as in relation to one another while the film 38 protects and fixes the PCM-filled tube sections 6. The illustrated dimensions of 3,5 mm for the diameter of the tube sections 6 and of 6,5 mm for their centre to centre spacing are to be understood as a typical example only. The sheet- and strip-like semi-finished product produced may be coiled and transported in a space-saving manner as well as being easily handled and cut to the respectively desired length. The length of the tube sections 6 is optional and depends on the setting of the production plant, as shown, for example, in FIG. 1. Relatively large sheet widths may be attained both by appropriately long dimensioned tube sections 6 as well as by employing an appropriately dimensioned roll width, e.g. comprising a wide feed roll 33 and one or more counter rolls 34, arranged side-by-side, comprising an appropriate number of hoppers 39 for supplying the PCM-filled tube sections 6 as well as comprising an appropriate number of extruder nozzles 37 or an extruder nozzle 37 comprising a nozzle aperture of appropriate length.

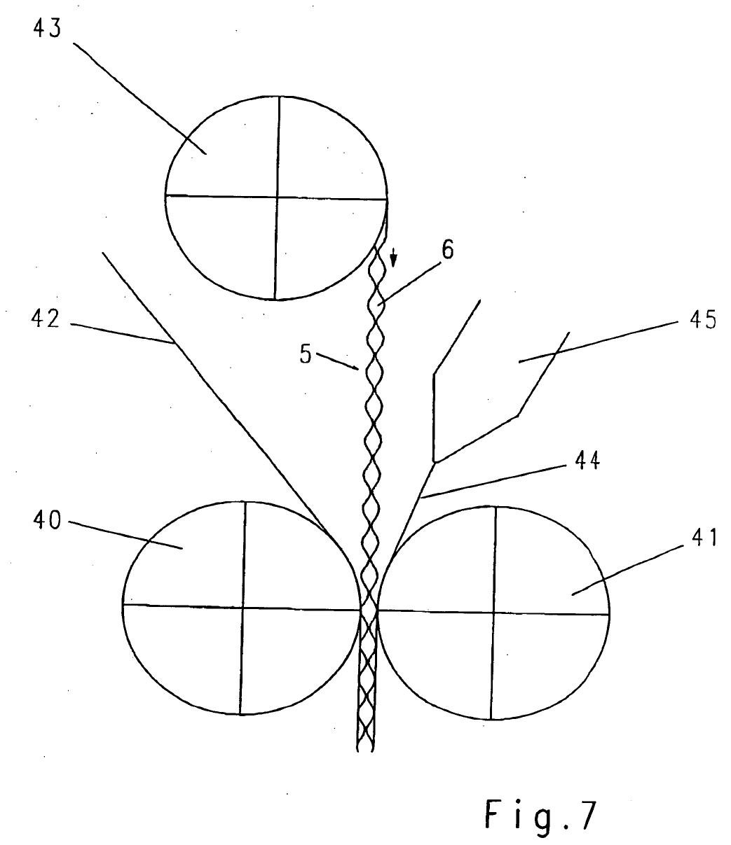

In the further embodiment according to FIG. 7 an endless non-woven fabric 42 is passed into the nip of two fluted rollers 40, 41, arranged in the manner shown in the drawing, and one or more strands 5 consisting of PCM-filled tube sections 6 are fed via a feed roller 43, which may also act as an uncoiling roller, e.g. formed in a means as shown in FIG. 4, to the roll nip and are coated with a film 44 from an extruder nozzle 45 on the side facing away from the non-woven fabric 42, as illustrated in the drawing. In this manner, a continuous sheet integrating PCM-filled tube sections 6 is produced. In this example as well, by an appropriate dimensioning of the roller widths as well as the chosen number of uncoiling rollers for the strands 5 etc., arranged parallel side-by-side, sheets of varying width may be produced in which an appropriate number of strands or cords 5 consisting of PCM-filled tube sections 6 have to be arranged side-by-side.

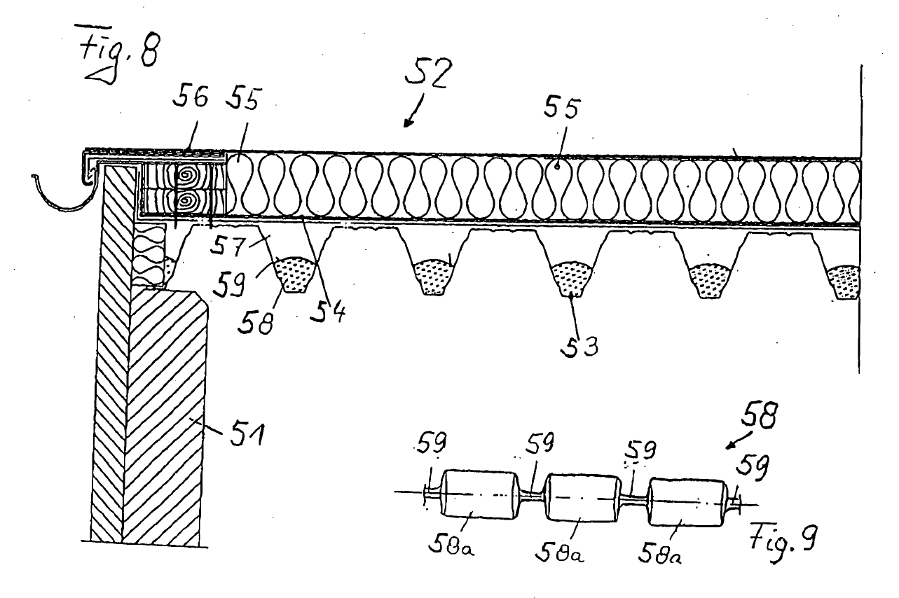

The building section of a lightweight construction shown in cross-section in FIG. 8 comprises a wall portion 51, on which a flat roof 52 rests, presenting a slight inclination. The flat roof 52 comprises on its underside a trapezoidal profile 53 of sheet metal and above the latter heat insulation 55 comprising a vapour seal 54 between the trapezoidal profile 53 and the heat insulation 55 and, as a top cover, a roof sealing sheet 56.

Elements 58 consisting of PCM are inserted into the cavities or corrugations 57 of the trapezoidal profile 53, which elements in the present embodiment have an approximately circular cross-section and a tubular sheathing 59 consisting of a tear-resistant, impervious and diffusion-proof foil. The elements 58 are preferably subdivided into individual sections 58a, which are sealed from one another and interconnected via constrictions 59 of the tubular sheathing material, which, however, can be easily severed, in order to allow cutting the elements 58 into sections in a simple manner. The elements 58 are appropriately inserted into the corrugations 57 on site after the trapezoidal profiles 52 have been mounted. It is, however, also possible to mount the trapezoidal profiles 52 with the elements 58 already inserted. Further above it has already been pointed out that the elements 58 may also be manufactured as rigid rods or pipes consisting of PCM comprising an appropriate sheathing, which may be inserted, as a whole, into the corrugations 57 or comparable cavities.

The element 58a comprises a flexible sheathing 59, adapting to shape variations of the element 58 consisting of PCM. The element 58 may, however, also consist of granules. In this case the sections 58a are separated from one another and introduced into the corrugations 57.

In this manner the space available in the corrugations 57 of the trapezoidal profile 53 is utilised for receiving PCM in the form of elements 58, 58a respectively, for absorbing thermal energy. As already set out at the beginning of the description, the PCM-elements 58, 58a, acting as heat storage means, cause a temperature reduction in this layer, below the roof, on hot summer days while on the other hand releasing heat at cool night temperatures, so that a balanced climate is brought about in the interior of the building. The tube sections 6 apparent from FIG. 7 may likewise be inserted into the corrugations 57. If no corrugations 57 are available for accommodating PCM-elements, as is the case in the present example, lengths of sheeting comprising tube sections 6 may be used alternatively as shown in FIG. 6.

Paraffin mixtures such as eicosane, nonadecane or oktadecane as well as salts, e.g. of calcium chloride hexahydrate or lithium nitrate-trihydrate, may, for example, be selected as PCM for the elements 58, 58a respectively.

For the manufacture of the tube 12 or the strand 5 or the tube sections 6 (FIGS. 1-7) and likewise for the PCM-elements (58, 58a respectively (FIGS. 8 and 9)) polyamide (PA) may be used, for example for PCM on a paraffin basis and in the event of using a PCM on a salt basis e.g. polyethylene (HDPE) or polypropylene (PP) or, in this case as well, polyamide (PA) may be used as the plastics.

1-27. (canceled)

28. Process for the production of elements made from or comprising a latent heat storing material known as PCM provided with a sheathing, said process comprising the steps of: extruding a tube from a synthetic material, feeding said PCM continuously or intermittently, filling or introducing said PCM into the extruded tube and subdividing the PCM-filled tube into tube sections or storing the PCM-filled tube.

29. The process according to claim 28, wherein said PCM-filled tube is stored coiled up.

30. The process according to claim 28, feeding the PCM in liquid or granular form or as a strand in sections or in endless form.

31. The process according to claim 28, wherein the step of filling the tube comprises filling the tube, after leaving the extruder nozzle and prior to entry into a cooling zone, with PCM.

32. The process according to claim 28, wherein said filling step comprises filling the tube with PCM in liquid form.

33. The process according to claim 28, further comprising making the tube from a plastic material and constricting the PCM-filled tube at predetermined locations in order to form said tube sections and heat sealing the constrictions.

34. The process according to claim 33, passing the PCM-filled tube through a press and said constricting and heat sealing steps being performed by heated pressing tools.

35. The process according to claim 34, wherein said constricting and heat sealing steps comprise constricting the tube and heat sealing at said predetermined locations one by one using reciprocating pressing tools.

36. The process according to claim 34, further comprising transporting the tube between two counter-revolving endless belts equipped with pressure and heat sealing tools and said constricting and heat sealing steps being performed at the predetermined locations.

37. The process according to claim 34, further comprising transporting the tube between two wheels equipped on a periphery with pressure and heat sealing tools and said constricting and heat sealing steps being performed at the predetermined locations.

38. The process according to claim 32, further comprising severing the PCM-filled tube sections at narrow points so that ends of the tube sections remain sealed.

39. The process according to claim 28, further comprising manufacturing a granular material consisting of PCM-filled pockets from a strand of separated tube sections.

40. The process according to claim 28, further comprising affixing the PCM-filled tube sections individually or interconnected as a strand to a carrier

41. The process according to claim 40, wherein said affixing step comprises affixing the PCM-filled tube sections individually or interconnected as a strand to one of a plastics non-woven fabric, a rigid plastics foil, and a flexible plastics foil.

42. The process according to claim 41, further comprising arranging the tube sections parallel side-by-side on the non-woven fabric or on the rigid or flexible foil.

43. The process according to claim 28, further comprising arranging and fixing the PCM-filled tube sections between a non-woven fabric and a film.

44. The process according to claim 43, further comprising bringing an endless non-woven fabric and an endless strand of PCM-filled tube sections together in a nip of a roller pair, interconnecting said fabric and said endless strand in said nip, and coating the tube filled sections with the film from an extruder nozzle on a side facing away from the non-woven fabric.

45. The process according to claim 43, further comprising drawing the film over the tube sections up to the non-woven fabric and fixing the film on the non-woven fabric between adjacent tube sections.

46. The process according to claim 43, wherein the non-woven fabric brings together tube sections individually fed from a hopper in a nip of a roller pair and further comprising coating the tube sections in the nip with the film from an extruder nozzle and fixing the film between the tube sections by adhesively bonding the film to the non-woven fabric.

47. An element comprising a latent heat storing material denoted as PCM, said element being manufactured from an endless PCM-filled tube made of synthetic material as tear-resistant, impervious and diffusion-proof sheathing and being designed as a section of a strand to be subdivided into sections as finished or semi-finished product, wherein the section forms an individually separated and sealed element.

48. The element according to claim 47, wherein the PCM-filled tube is constricted and heat sealed at predetermined intervals in order to form tube sections forming a coherent strand.

49. The element according to claim 48, wherein the tube sections form a granular material consisting of PCM-filled pockets.

50. The element according to claim 47, wherein the PCM-filled tube sections individually or forming a continuous strand are affixed to a carrier

51. The element according to claim 50, wherein said carrier is one of a non-woven fabric of plastics, a flexible plastics foil, and a rigid plastics foil.

52. The element according to claim 47, wherein a phase change temperature of the PCM is adapted to an intended use.

53. The element according to claim 52, wherein said phase change temperature is in the range of 15-40° C.

54. The element according to claim 52, wherein said phase change temperature is in the range of 20-35° C.

55. The element according to claim 47, wherein the sheathing is flexible and permits shape variations of the elements consisting of PCM in a pulverised, granular, liquid or paste-like state.

56. The element according to claim 55, wherein the sheathing is balloon-like.

57. The element according to claim 55, wherein the sheathing is tubular.

58. The element according to claim 47, wherein the sheathing is multi-layered.

59. The element according to claim 47, wherein the PCM possesses a latent heat of at least 50 KJ/kg.

60. The element according to claim 47, wherein the PCM consists of a paraffin mixture.

61. The element according to claim 60, wherein the paraffin mixture is selected from the group consisting of eicosane, nonadecane and oktadecane.

62. The element according to claim 47, wherein the PCM is selected from the group consisting of a salt and a salt hydrate.

63. The element according to claim 62, wherein the PCM is a salt hydrate selected from the group consisting of calcium chloride hexahydrate and lithium nitrate-trihydrate.
